(19) United States
(12) Patent Application Publication
(10) Pub. No.: US 2025/0033682 A1
(43) Pub. Date: Jan. 30, 2025

(54) TELEVISION TRANSPORTER

(71) Applicant: BRYAN FREEMAN, APPLE VALLEY, CA (US)

(72) Inventor: BRYAN FREEMAN, APPLE VALLEY, CA (US)

(21) Appl. No.: 18/784,604

(22) Filed: Jul. 25, 2024

Related U.S. Application Data
(60) Provisional application No. 63/529,309, filed on Jul. 27, 2023.

(51) Int. Cl. B62B 3/10

(52) U.S. Cl. CPC B62B 3/108; B62B 2202/56; B62B 2203/04

(57) ABSTRACT

Methods and assemblies for securing objects in position for transportation. A transport assembly includes one or more brackets or bars for holding a receiver which is in turn configured to hold the item to be transported in a protected, hanging configuration. The apparatuses may find particular use for the transport of flat screen televisions and other video displays. A receiver for holding items in the transport assembly is disclosed, as well as methods for using such receivers and/or transport assemblies.

### CROSS REFERENCE TO RELATED APPLICATIONS

The present application claims the benefit of and priority to US Prov. Pat. App. No. 63/529,309, filed Jul. 27, 2023, titled TELEVISION TRANSPORTER, the disclosure of which is incorporated herein by reference.

### BACKGROUND

Video displays, such as televisions and computer monitors, have become thinner and larger with advances in LCD technology in particular. When the owner of a large flat-screen television moves from one residence to another, for example, or otherwise needs to move such a device, the typical approach is to wedge the television between other items on a moving truck to keep it upright and protected, sometimes using a box, bubble wrap, and/or a blanket to provide additional protection. Professional movers typically put the television in a large cardboard box. If the load in a moving truck shifts, however, the screen or other parts of the video display can be damaged. The screen may instead be laid flat, however, some video displays also cannot be transported, without risk of damage, when laid flat.

Some artwork, such as paintings and framed photographs, as well as mirrors, tend to be large, flat, and difficult to safely transport. The most common advice for moving such items is to carefully wrap the item, using fabric, foam, bubble wrap and the like, and place inside a large box. As with televisions and other video displays, the artwork or mirror in the box and bubble wrap may then be wedged between other large objects in the back of a moving truck, leaving the box and its contents at risk if the load shifts. Moreover, the use of bubble wrap and cardboard for such shipping tends to be wasteful.

New and alternative solutions to aid in the transportation of such items are much desired.

### Overview

The present inventor has recognized, among other things, that a problem to be solved is the need for new and/or alternative devices or systems to secure a video display for transportation. In some examples, an item to be transported, such as a television, large mirror, or artwork, is first placed in a receiver, which folds along a line to form an envelope or bag, with open sides that can be secured by the use of ties, grommets, hook-and-loop fastener, or the like. The side edges are thus reversibly secured (that is, by reversibly secured, stitching, sewing and/or rivets would not be used; removeable ties, clips, and/or hook-and-loop fasteners can be used).

The receiver may be made of canvas, cloth, a sheet of flexible plastic, etc. Once folded, the receiver has an upper edge which is adapted to be received on one or more brackets or bars, thus holding the item to be transported in a hanging configuration. The brackets or bars are part of a transporter assembly having a frame and a protective outer side. The receiver may instead have loops or other features for attachment thereon. The transporter assembly may be secured in a vehicle such as a moving van or truck, or may be secured to another transporter assembly for placement on one or more pallets. Further details are provided in the detailed description that follows.

This overview is intended to provide an introduction to the subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1 and 2 are front elevation views of an illustrative transport assembly;

FIG. 3 is a rear elevation view of an illustrative transport assembly;

FIGS. 4-8 are top views showing use of the illustrative transport assembly to receive and secure an item to be transported;

FIGS. 9-12 are views of a receiver for use with the transport assembly; and

FIG. 13 shows, in block form, an illustrative method.

### DETAILED DESCRIPTION

The following description focuses primarily on the use of the transport assembly as described for securing and transporting video displays, such as large flat screen televisions. Some examples may be used additionally or alternatively to transport other items having a large area and thin profile, such as paintings, photographs, other artwork, stained glass, and/or mirrors, for example.

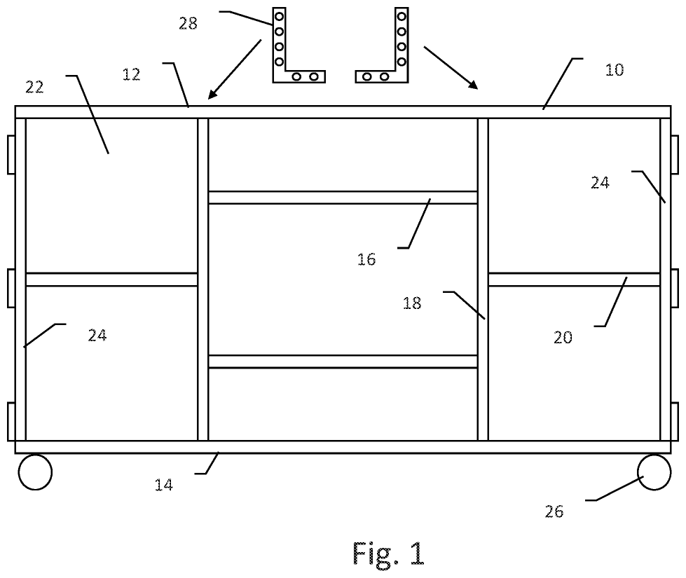

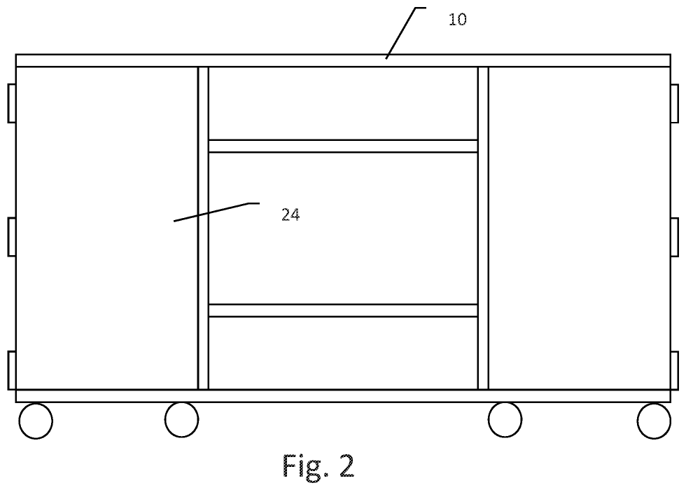

FIGS. 1 and 2 are front elevation views of an illustrative transport assembly. The “front” as used in FIGS. 1 and 2 would be the side that faces against a truck or other vehicle wall, or which may face a second transport assembly, as desired. In FIG. 1, the assembly 10 includes a top bar 12 and a bottom bar 14, with an internal support structure of horizontal bars 16, 20 and vertical bars 18. The internal support structure is illustrative and may take other forms, as desired. An outer wall 22 is shown as well, and the structure 10 includes doors 24, which in the view of FIG. 1 are open and would extend out of the page directly at the viewer. The assembly 10 is supported, at least in part, by castors 26. L-shaped bars are shown at 28, and would insert as illustrated by the arrows, in general alignment with the vertical bars 18, though such alignment is not required and may be omitted, with the L-shaped bars 28 instead configured to secure into openings (not shown) in the top bar 12. As shown below, instead of L-shaped bars 28, pivoting brackets may be provided. The L-shaped bars 28 or brackets (below) are used to support a receiver that holds an item to be transported such as a television. FIG. 2 shows the doors 24 in a closed position.

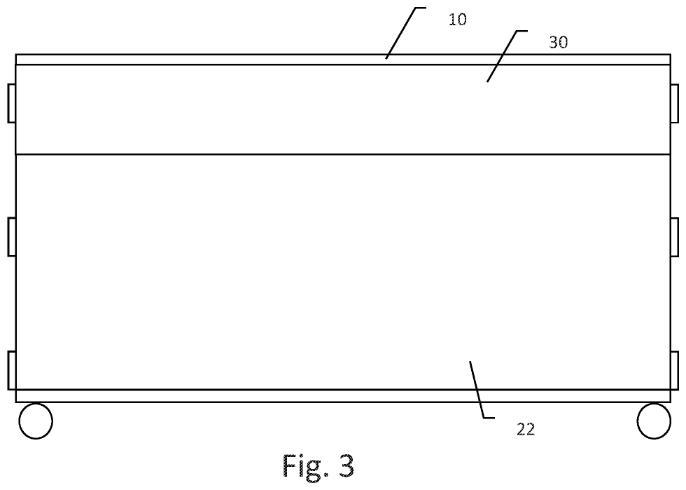

FIG. 3 is a rear elevation view of the transport assembly 10. The outer wall 22 is visible, and a cover or lid 30 that is pivotably attached to the top bar, as will be further explained below. The transport assembly 10 may be made of any suitable material or combination of materials, including for example, metal (steel, aluminum, tin, copper), wood, plastics and/or synthetics (polyvinyl chloride, for example), composites, etc. Aluminum is one material in particular that may be useful for its light weight and durable nature. The height of the transport assembly may be in the range of 40 to 60 inches, with 48 inches being illustrative for some examples. The transport assembly may be as wide as the location allows, for example, if positioned in the back of a truck. Some examples may be in the range of about 85 inches wide, for example. These sizes are merely illustrative.

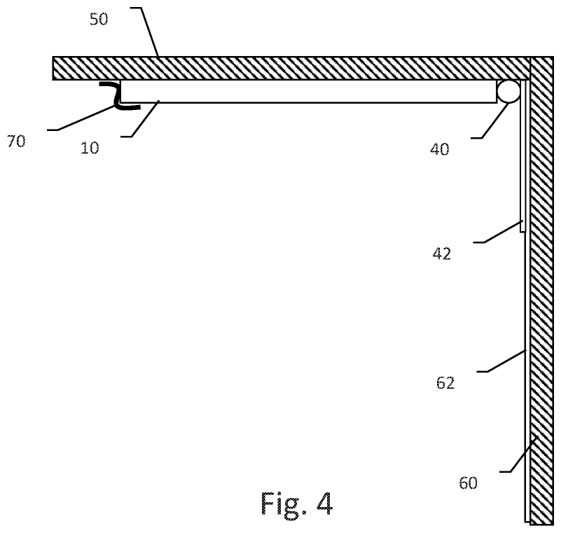

FIGS. 4-8 are top views showing use of the illustrative transport assembly to receive and secure an item to be transported. FIG. 4 shows a stowed configuration. The transport assembly 10 is positioned against a first wall 50 of a truck box. A second wall 60 of the truck box is also shown, and includes a bumper rail 62. A piece of metal channel 64 is secured to the wall 60 or bumper rail 62, and is in a sliding relationship with a pivot bar 40 that is pivotably secured to one of the sides of the transport assembly 10. One or more straps 70 may be provided to hold the transport assembly 10 in the stowed position shown. The depth of the transport assembly when stowed may be as little as 1.5 to 4 inches, for example and without limitation. A depth of less than 4 inches, or less than 3 inches, may be desirable to limit the amount of truck box space taken when the assembly 10 is not in use.

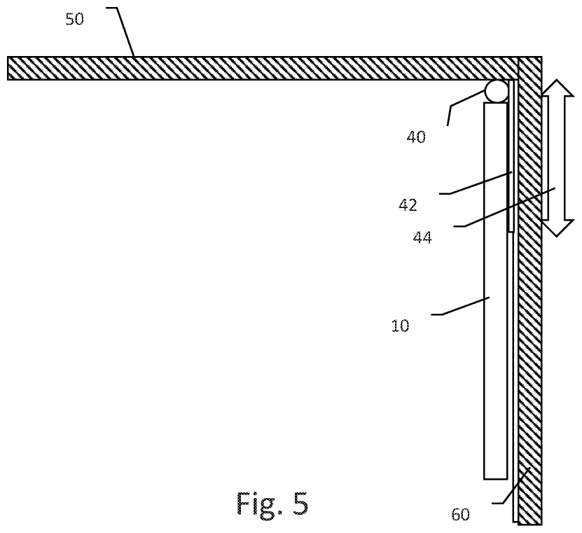

FIG. 5 is another top view; here the strap 70 (not shown) has been released, and the assembly 10 is pivoted using pivot bar 40 into position adjacent the second wall 60.

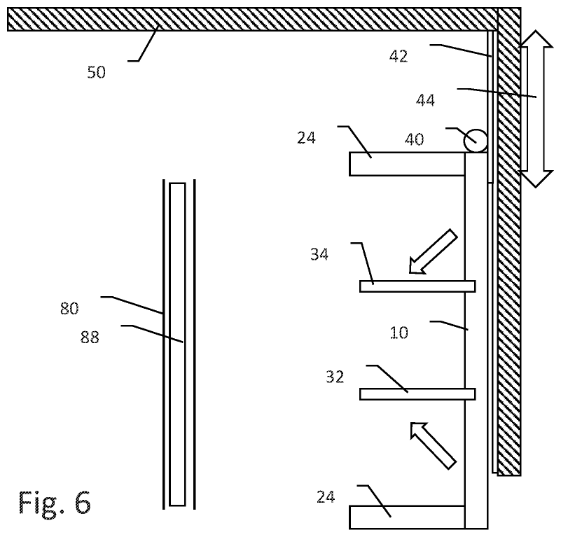

FIG. 6 illustrates a next step. Here, the pivot bar 40 is slid along the channel 42 in direction 44, bringing the assembly 10 away from the first wall 50. The doors 24 are now opened, and the brackets 32, 34 are shown pivoted to an open position from their closed position behind doors 24, as illustrated by the arrows. If desired, the brackets 32, 34 and doors 24 may lock into the 90-degree extended position shown. Rather than brackets 32, 34, the L-bars of FIG. 1 may instead be used.

FIG. 6 also shows how an item to be transported is prepared. The item 88 is positioned inside of a receiver 80, which may be a canvas sheet or other flexible material (other fabrics, such as hemp may be used, for example, or a flexible plastic, as desired).

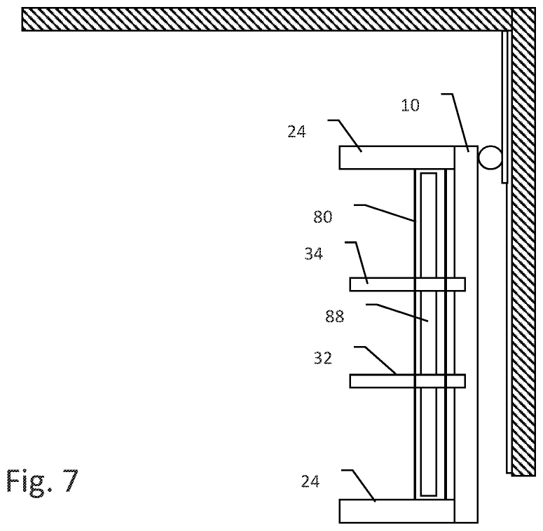

FIG. 7 shows the item to be transported at 88, inside the receiver 80, and now positioned in the transport apparatus 10. The receiver 80 is configured to hang from the brackets 32, 34 (two brackets are shown; more may be provided as desired), such as by having openings reinforced (such as with grommets or by stitching a layer of material thereabout) that can slide over the brackets 32, 34, or with additional couplers such as carabiners, hooks, eyelets, etc. End edges of the receiver 80 are shown inside the doors 24. The castors shown in FIGS. 1-3 may include multiple wheels such as wheels on the ends of each door 24, and wheels on the bottom bar, supporting the structure as shown in FIG. 7.

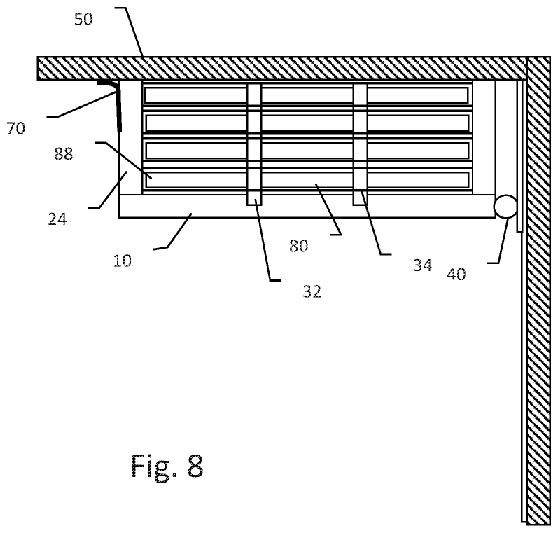

FIG. 8 illustrates the assembly 10 now in a secured position. The assembly 10 pivots about the pivot bar 40 to bring the open doors 24 adjacent to the first wall 50. A strap 70 can be used to secure the door (or doors) to the first wall 50, as shown. The receiver 80 hangs from the brackets 32, 34 holding the item 88 therein. One or more spacers may be used to prevent sway of the item 88, if desired. Alternatively, a strap may be used to hold the receiver 80 against the outer wall of device 10, or relative to the bottom bar, etc. to prevent such sway. In the illustration, four items to be transported at shown, each inside its own receiver; more or fewer may be used at any given time, and the side of doors and brackets 32, 34 may be selected to accommodate a desired quantity of items to be transported.

In an illustrative example, the doors 24 and brackets 32, 34 have a length of about 14 to 24 inches. Size may be selected up to 36 inches or more, if desired. As the length gets longer, a support bar may be added/included at the free ends of the brackets 32, 34 and/or doors 24 to assist in holding the weight of the items to be transported as well as the receivers.

In some examples, the first wall 50 is a front wall of the truck box, and the second wall 60 is a side wall. In other examples, the assembly can be secured using straps on both ends (similar to strap 70) and attached to a single wall, whether front or side, of a truck box. In still other examples, strap 70 may hold two assemblies together, front to front, forming an enclosure therebetween when in the expanded position with the doors open. Straps 70 can be used to secure the doors and top lids, when two assemblies are coupled together; such coupling can be used to hold the devices on pallets for other forms of transportation than trucks, such as when transporting on a plane or in a cargo ship.

The transport assembly shown in FIGS. 1-8 is one example of a transport assembly that may be used. In some examples, the wheels on the bottom of the assembly can be omitted. For example, professional movers may be accustomed to lift-assistance straps (sometimes called shoulder straps, or furniture moving straps), generally looped over the shoulders of each of two movers, who stand on opposite sides of an items to be moved, lift, and then use the straps and their hands, arms or body to maintain the lifted item. Such straps can also be used with the transport assembly, whether one as shown in FIG. 1-8, or a different type. Any transport assembly having features from which a receiver can be hung may be used for hauling the receivers shown herein.

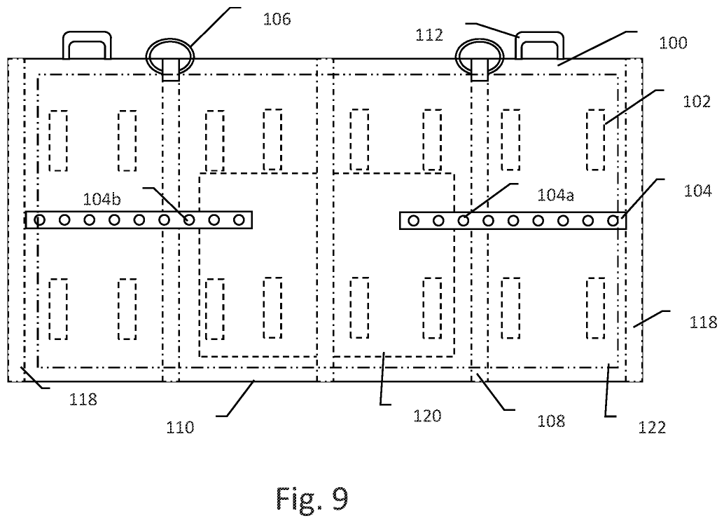

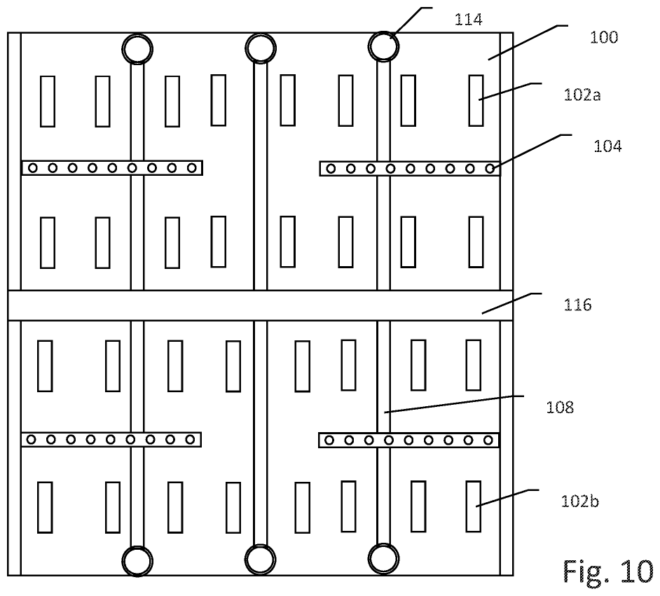

FIGS. 9-10 are views of a receiver for use with a transport assembly. The receiver 100 may be, for example, made of canvas or other materials, as noted above. In the example of FIG. 9, the receiver 100 is shown in a folded over or envelope configuration, for receiving an item to be transported, such as a smaller item as shown in phantom at 120, or a larger item shown in phantom at 122 (it being understood that only one of 120 or 122 would be packed, typically in a single receiver, though it is envisioned that more than one item could be packed).

The folded configuration thus has sides or edges at 118 which are generally open as the folded configuration is reached, which can then be closed, preferably reversibly. For example, the receiver may have, on an internal wall, hook and loop fasteners 102 (shown in phantom), such as Velcro-type attachments for holding the sides of the receiver together. The edges at 118 may also have hook and loop fasteners to prevent an item 120 from falling out either edge. The internal wall hook and loop fasteners 102 may be used to provide additional securing of smaller items 120 by being secured thereabout. These internal fasteners 102 may be omitted. Once folded, the sides may be reversibly secured by, for example, manually crimping to engage hook-and-loop fasteners, or placing clips, ties (zip ties for example), carabiners, pins (oversized safety pins for example) or other removeable securing apparatuses through the material (including, if present, any reinforcing material/layer/strap) at the edges 118, which may include grommets or pre-defined holes if desired. Some examples may use magnets sewed or built-in to the edges or elsewhere, though the use of magnets may in some cases be omitted due to concerns about interaction of magnetic fields with electronics and/or screen of an item to be transported. The top edge may also be secured or closed in a manner similar to the side edges, if desired, or may be left open and/or may omit any such additional structure for closing the top edge.

Straps 108 may provide added strength. For example, the main portions of the receiver 100 may be made, without limitation, of a flexible, strong, yet lightweight material such as canvas, a flexible plastic, or a blend of such materials, including blends made by weaving together strands or fibers, and multi-layer constructions. Straps may be added at the edges or in the middle as shown at 108, or along the outside edges at 118 as shown in FIG. 9, such as nylon seatbelt webbing and/or similar materials of high strength and durability. Making the entire receiver of seatbelt webbing may make for more stiffness, weight or expense, but is also an option in some examples. Several examples, however, use nylon webbing as a strap and reinforcing material at desired locations, in particular as shown in FIGS. 10-12, below. Such nylon webbing can be attached using stitching, as desired, or any other attachment means (adhesive, heat, weld or sonic bonding, rivets, etc.).

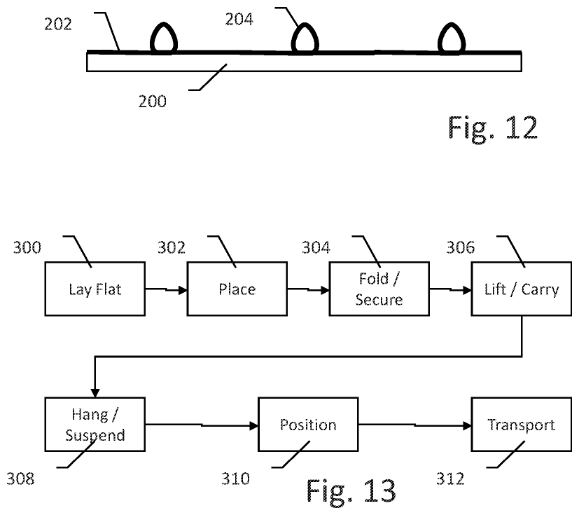

In the example of FIG. 9, at the top of the receiver are rings 106 that can be used for hanging the receiver 100 on the brackets described previously. Rings 106 may be secured by straps 108, for example. The rings may be separate pieces of metal or durable plastic, such as stainless-steel rings, or aluminum rings, as desired. Rather than separate rings, loops of the straps 108 may be used, as shown below in FIG. 12. In other examples, grommets may be built into the receiver 100 as shown in FIG. 10, rather than rings 106 that extend upward or loops made of the straps 108.

In addition or as an alternative to the fasteners 102, a series of openings, such as having grommets may be provided as shown at 104, through which ties for example may be placed to effectively re-size the envelope defined inside the receiver 100 for holding the item 120. The grommets or openings 104a/b may be positioned over a reinforcing layer, again, such as a nylon webbing of the type used for seat belts. For example, ties passed through grommets 104a and 104b can prevent the item 120 from sliding to the left and right inside the receiver 100 as shown in FIG. 9. Such grommets may be used on the outer edges of the receiver, such as along the edges at 118, which may be reinforced using nylon webbing or other reinforcing material and, when grommets are used, zip ties, for example, may be used to reversibly secure the edges 118.

For manual carrying purposes, such as loading and unloading to the carrier assembly, handles shown at 112 may be provided. This may be useful in the event that, for example, a transport assembly is positioned in a truck or in a separate room from the location the item to be transported is located.

FIG. 10 shows another view of the receiver 100, with the receiver 100 unfolded to illustrate the interior features thereof. Here, grommets are shown at 114, rather than the rings. Instead of two rings as in FIG. 9, three grommets are shown; thus, three brackets may be used in a corresponding transporter assembly. A center portion 116 may be reinforced to provide a seam/width at the bottom, or may be covered with a soft material such as felt to prevent scratching the bottom of an item to be transported. The center portion 116 may be adapted to bend, and thus reinforcement may be provided to prevent tearing/breaking of the material, as desired. The center portion at 116 may use a similar nylon webbing for reinforcement or may, instead, have a double layer of the canvas or other material used for the rest of the receiver. In some examples another material, such as a layer of felt or soft material, may be positioned on the inside of the receiver to prevent or at least avoid scratching the item to be transported. If desired, a thin foam sheeting, or edge pieces of cardboard may be placed on the item to be transported, at corners thereof or along long edges, as desired.

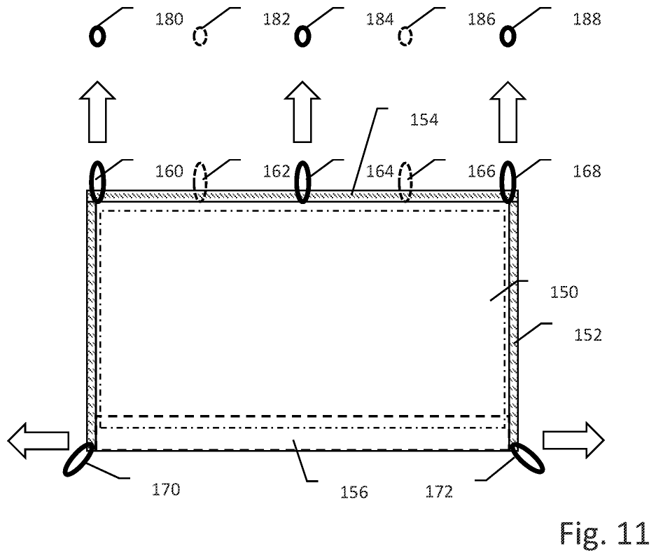

FIG. 11 shows another view of the receiver. The item to be transported 150 is shown in phantom, and the receiver is shown with reinforcing pieces 152 along the side edges and 154 along the top edge (the piece 154 would be part of both the opposing edges that are adjacent one another in the folded configuration of FIG. 11). A padding piece 156 may optionally be positioned on the bottom (the padding piece 156 would be on the inside and so is also shown in phantom). The reinforcing pieces 152, 154 line the edges, and may be constructed as shown in FIG. 12 with loops that extent outward to aid in handling as well as hanging the receiver. Thus there may be loops at any of positions 160, 162, 164, 166, 168, 170, 172. In an example, three top loops 160, 162 and 166 are used along with bottom loops 170, 172. The bottom loops 170, 172 can be used for stability purposes and attached to hooks, straps or even flexible cords (bungee cords) to prevent provide stability and/or prevent sway during transport. The bottom loops may be omitted, if desired. Any two or more of the top loops 160, 162, 164, 166, 168 may be used. Having multiple loops available may allow for multiple transport assembly configurations to be used with a given receiver design.

It should be noted that the receiver is shown folded over, so that each of 160, 162, 164, 166, 168, actually represents two loops, one from each of the upper edges of the receiver. These may be hung together (in pairs, for example) on a corresponding bar, hook or ring of the transport apparatus, so that the upper edge is held in a generally closed (though not necessarily sealed or hermetic) state. For example a set of hanging structures is shown at 180, 182, 184, 186, 188 and may take the form of, for example and without limitation, bars, hooks, straps, rings, clips, carabiners, etc. Less than all of the hanging structures shown may be used; as few as one hanging structure may be used at the top edge (if used in combination with the bottom loops, for example), or two, three, four or all five shown, or more than those shown, may be used. It should be understood that the number of hanging structures or other securing structures that are used, if increased, may increase system complexity and time required, a burden offset by potentially greater security/safety for the item to be transported, which can include controlling position, motion (vibration, bouncing and/or sway), as well as providing additional redundancy in the event a strap, hanging structure, grommet, etc. becomes damaged or worn, for example after multiple uses. In an example, the folding step is performed to bring a first strap or ring on a first edge of the receiver to be adjacent to a second strap or ring on a second edge of the receiver, and the first strap or ring is hung from the same hanging structure as the second strap or ring in the subsequent hanging step.

The arrows illustrate forces applied by the final configuration. The overall receiver with transport item 150 is supported in the vertical direction by the top loops, whichever are selected/used. The bottom loops 170, 172 can be used to provide lateral forces, keeping the bottom portion of the receiver in from wrinkling or folding over, and, as noted, helpful to prevent sway during transport.

FIG. 12 illustrates how loops 204 can be imparted. The thickness of materials is exaggerated. The main material, noted above as canvas, cloth or any suitable, flexible plastic, such as a woven plastic, is shown at 200. The reinforcing strap 202 is attached by stitching in some examples; heat attachment, adhesive, or sonic or other welding process can be used if desired instead, but it is anticipated that some examples will simply using heavy duty stitching. For example, the type of stitching used for seat belts may be used, and a nylon webbing of the type used for seat belts can be used as the reinforcing strap 202.

The receivers shown above can be sized to accommodate larger or smaller items, including televisions and particularly flat-screen televisions. Televisions up to 100 inches or more are known, with the size (for example, 85 inches) being taken along a diagonal across the screen, so the actual width and height are different from the “size”. For example, an 85 inch television may have a width in the range of about 76 inches wide and 44 inches tall, though the exact dimensions may vary by a few inches depending on aspect ratio and the area of the television that surround the screen. A receiver may have a width (when unfolded) of up to about 120 inches, with a 96 inch width being sufficient for the vast majority of users, and a height of up to 120 inches (as folded, about 60 inches height), with a 96 inch height also sufficient for most users to yield a folded height of about 48 inches. When folded with an item to transport therein, some of the height will be taken up due to the width of the object inside the receiver, so that the effective height, for example, of a 96-inch square receiver, once folded and with a television in position therein, may be about 46 inches, sufficient for a commonly sized 85-inch television. Larger or smaller dimensions can be used. As can be seen, the receiver may be generally square when laid out flat, and is used to carry a television in a folded over state.

A non-limiting and illustrative example may take the form of a receiver for use for transporting a television, comprising: a body 100 in the form a rectangular or square sheet of material, having a first edge, a second edge opposing the first edge, a third edge, and a fourth edge opposing the third edge; a plurality of reinforcing straps attached to the body including a first strap 154 along the first edge, a second strap 154 along the second edge, a third strap 152 along the third edge, and a fourth strap 152 along the fourth edge; and at least one intermediate strap extending parallel to the third edge 108; and an added layer 116 extending from a midpoint of the third edge to a midpoint of the fourth edge; wherein the first strap comprises a first loop 204, and the second strap comprises a second loop 204 (as noted in FIG. 12, the loop structures can be used for any of the described straps), positioned such that when the body is folded to bring the first edge adjacent to the second edge, the first loop and second loop are adjacent to one another, such that the first loop and the second loop may hang from a single hanging structure; wherein the body is formed from canvas, and each of the plurality of reinforcing straps are formed of nylon webbing; wherein when the body is folded to bring the first edge adjacent to the second edge, the added layer 116 provides at least one of reinforcement or padding to an object received in the receiver when the first loop and the second loop hang from the single hanging structure.

Additionally or alternatively, the receiver may include a means for reversibly attaching the third edge to itself when the body is folded to bring the first edge adjacent to the second edge, the means for reversibly attaching extending along the third edge. Such means may take the form of a hook and loop structure attached to the canvas or as part of the third strap. Additionally or alternatively, such means may take the form of one or more openings through the third strap and third edge, adapted for receiving any of a hook, a tie, a loop, or a carabiner. Such openings may include grommets or other reinforcing layer. Additionally or alternatively, the first and second edges each comprise one or more handles for use when lifting the receiver when a television or object to be transported is received therein.

FIG. 13 shows in block form an illustrative method. A method of transporting a television may include positioning a receiver in an un-folded state, such as a state as shown in FIG. 10. This may be characterized as laying the receiver flat, indicated at 300, or placing the receive in an open position, understood as unfolded or open as shown in FIG. 10. The method next includes placing the television on a first side of the receiver 302, and folding 304 over a second side of the receiver to bring first and second opposing edges of the receiver together at an open seam or top edge or side, thereby also defining first and second open sides and a closed, folded side. Step 304 may also include, as indicated, securing the television in position such as by using grommets and hooks, or hook-and-loop fasteners, as described in several examples above. Ties may be used, including zip ties, as desired.

Next, the method may include lifting at the top edge and/or side edges to stand the television inside the receiver upright as indicated at 306, and carrying the television as held in the receiver to a transport assembly. Next, the receiver may be hung, suspended, positioned or placed, as indicated at 308, relative to a transport assembly, such as that in FIGS. 1-8, above, and/or a different design, and suspended in the transport assembly. Suspension of the receiver may be performed by the use of one or more bars or hooks to engage with openings or straps along the top edge and/or side edges of the receiver. In an example, the receiver has straps that can be received on a bar or hook, or captured in or tied to a carabiner or ring, or otherwise attached to any other hanging structure, of the transport assembly. In another example, the receiver has openings, which may be reinforced, such as by use of a grommet or stitching an additional layer of material thereabout, which can be hooked or captured on any of the noted hanging structures (bar, hook, carabiner, ring, etc.).

The method steps 300 to 308 may be repeated for more than one television or other object to be transported. The transport assembly is then positioned as desired in a moving vehicle, which may be a moving truck for example, or any other conveyance, as indicated at 310. Finally, the item is transported, as indicated at 312.

While the discussion of FIG. 13 focuses on transporting one or more televisions, any other object can be transported using the disclosed receivers, transport assemblies and/or methods, such as artwork and/or mirrors, for example. A light display or sign (such as a novelty lighted sign) may be transported similarly. Some such items may optionally be placed in a first protective structure, such as a box, prior to placement in a receiver. The receiver is useful, however, to limit movement, and even vibration (vibration or bouncing of a transport vehicle, such as a truck, may not fully translate through the transport assembly to the receiver, and the receiver itself acts as a damper on vibration. If desired, motion damping structures may be built into the transport assembly, by having layers, wraps or other structures on the support structures or bars, for example, as well as springs or other dampers between wheels and the transport structure, for example.

An illustrative, non-limiting example may take the form of a method of transporting a television comprising: laying a receiver for the television in an open position, the receiver having a length extending between first and second edges, and a width between third and fourth edges; placing the television on the receiver in on a first half thereof; folding the receiver over the television along the length thereof, such that first edge is brought to the second edge, and the length is divided in half, thereby folding the third edge onto itself and the fourth edge onto itself; lifting the television while inside the receiver to an upright position; and hanging the receiver in a transport assembly with the television in the upright position. In some examples, the lifting step to place the television in the receiver in an upright position is performed before hanging the receiver in the transport assembly. The lifting step may be performed, if desired, by first positioning the receiver and television in the transport assembly and then using the transport assembly to transfer to an upright position.

Additionally or alternatively, the first edge of the receiver comprises first strap, and the second edge of the receiver comprises a second strap, and the folding step is performed such that the first strap and the second strap are placed adjacent one another; and the hanging step comprises placing engaging the first strap and the second strap with a first hanging structure of the transport assembly.

Additionally or alternatively, the third edge of the receiver comprises a third strap and a fourth strap, and: the folding step is performed such that the third strap and the fourth strap are placed adjacent one another; and the hanging step comprises placing engaging the third strap and the fourth strap with a second hanging structure of the transport assembly.

Additionally or alternatively, the first hanging structure provides vertical support to the receiver, and the second hanging structure limits motion of the receiver.

Additionally or alternatively, the hanging structure is one of a bar, hook, strap, ring, clip, or a carabiner.

Additionally or alternatively, the third edge of the receiver comprises a first strap and a second strap, and: the folding step is performed such that the first strap and the second strap are placed adjacent one another; and the hanging step comprises placing engaging the first strap and the second strap with a hanging structure of the transport assembly.

Additionally or alternatively, the receiver comprises reinforcing material along the first, second, third and fourth edges, and the reinforcing material is structured with a plurality of straps, and the hanging step comprises engaging at least one of the straps with a hanging structure of the transport assembly.

Additionally or alternatively, the method also includes securing the third edge to itself after the folding step using a hook-and-loop structure disposed along the third edge.

Additionally or alternatively, the method also includes securing the first edge to the second edge after the folding step using hook-and-loop structures disposed along the first edge and the second edge.

Additionally or alternatively, the method also includes securing the third edge to itself after the folding step using one or more ties, carabiners, rings, or straps.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “a” or “an” are used, as is common in patent documents, to include one or more than one, independent of any other instances or usages of “at least one” or “one or more.” Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims.

Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A method of transporting a television comprising:
laying a receiver for the television in an open position, the receiver having a length extending between first and second edges, and a width between third and fourth edges
placing the television on the receiver in on a first half thereof;
folding the receiver over the television along the length thereof, such that first edge is brought to the second edge, and the length is divided in half, thereby folding the third edge onto itself and the fourth edge onto itself;
lifting the television while inside the receiver to an upright position; and
hanging the receiver in a transport assembly with the television in the upright position.

2. The method of claim 1, wherein the first edge of the receiver comprises first strap, and the second edge of the receiver comprises a second strap, and:
the folding step is performed such that the first strap and the second strap are placed adjacent one another; and
the hanging step comprises placing engaging the first strap and the second strap with a first hanging structure of the transport assembly.

3. The method of claim 2, wherein the third edge of the receiver comprises a third strap and a fourth strap, and:
the folding step is performed such that the third strap and the fourth strap are placed adjacent one another; and
the hanging step comprises placing engaging the third strap and the fourth strap with a second hanging structure of the transport assembly.

4. The method of claim 3, wherein the first hanging structure provides vertical support to the receiver, and the second hanging structure limits motion of the receiver.

5. The method of claim 2, wherein the hanging structure is one of a bar, hook, strap, ring, clip, or a carabiner.

6. The method of claim 1, wherein the third edge of the receiver comprises a first strap and a second strap, and:
the folding step is performed such that the first strap and the second strap are placed adjacent one another; and
the hanging step comprises placing engaging the first strap and the second strap with a hanging structure of the transport assembly.

7. The method of claim 1, wherein the receiver comprises reinforcing material along the first, second, third and fourth edges, and the reinforcing material is structured with a plurality of straps, and the hanging step comprises engaging at least one of the straps with a hanging structure of the transport assembly.

8. The method of claim 1, further comprising securing the third edge to itself after the folding step using a hook-and-loop structure disposed along the third edge.

9. The method of claim 8, further comprising securing the first edge to the second edge after the folding step using hook-and-loop structures disposed along the first edge and the second edge.

10. The method of claim 1, further comprising securing the third edge to itself after the folding step using one or more ties, carabiners, rings, or straps.

11. A receiver for use for transporting a television, comprising:
a body in the form a rectangular or square sheet of material, having a first edge, a second edge opposing the first edge, a third edge, and a fourth edge opposing the third edge;
a plurality of reinforcing straps attached to the body including a first strap along the first edge, a second strap along the second edge, a third strap along the third edge, and a fourth strap along the fourth edge; and at least one intermediate strap extending parallel to the first edge; and
an added layer extending from a midpoint of the third edge to a midpoint of the fourth edge;
wherein the first strap comprises a first loop, and the second strap comprises a second loop, positioned such that when the body is folded to bring the first edge adjacent to the second edge, the first loop and second loop are adjacent to one another, such that the first loop and the second loop may hang from a single hanging structure;
wherein the body is formed from canvas, and each of the plurality of reinforcing straps are formed of nylon webbing;
wherein when the body is folded to bring the first edge adjacent to the second edge, the added layer provides at least one of reinforcement or padding to an object received in the receiver when the first loop and the second loop hang from the single hanging structure.

12. The receiver of claim 11, further comprising a means for reversibly attaching the third edge to itself when the body is folded to bring the first edge adjacent to the second edge, the means for reversibly attaching extending along the third edge.

13. The receiver of claim 12, wherein the means for reversibly attaching comprises a hook and loop structure.

14. The receiver of claim 12, wherein the means for reversibly attaching comprises one or more openings through the third strap and third edge, adapted for receiving any of a hook, a tie, a loop, or a carabiner.

15. The receiver of claim 11, wherein the first and second edges each comprise one or more handles for use when lifting the receiver when a television or object to be transported is received therein.
